(19) United States
(12) Patent Application Publication
(10) Pub. No.: US 2024/0249368 A1
(43) Pub. Date: Jul. 25, 2024

(54) SYSTEM AND METHOD FOR PROVIDING A PLATFORM FOR MATCHING USERS IN THE PROCESS OF WORK RELOCATION

(71) Applicant: Nicholas Alexander Kutheis, Kirkwood, MO (US)

(72) Inventor: Nicholas Alexander Kutheis, Kirkwood, MO (US)

(21) Appl. No.: 18/101,486

(22) Filed: Jan. 25, 2023

(51) Int. Cl. G06Q 50/00

(52) U.S. Cl. CPC G06Q 50/01

(57) ABSTRACT

A platform for matching users in the process of work relocation, general relocation, and travel, the system including at least one user computing device in operable connection with a user network. An application server is in operable communication with the user network to host an application system for providing a communication platform for work relocation, general relocation, and travel, the application system having a user interface module for providing access to the application system through the user computing device. A matching module in communication with the application program to match two or more users using a plurality of user-input parameters. A communication module permits the two or more matched users to communicate using the communication platform.

### TECHNICAL FIELD

The embodiments generally relate to systems and methods for matching users and more specifically relates to providing a platform for matching and communicating with users based on location and date parameters associated with work relocation, general relocation, or travel.

### BACKGROUND

The desire to connect with others is prevalent in human nature. Historically, connecting with others required in-person interactions. Advances in technology, namely, the Internet, has allowed humans to connect with one another remotely. In the current arts, many platforms exist where users in a similar region can connect based on similar interest, relationship desires, etc. While these systems may be effective, they do not allow users to connect when outside of a particular region, or to connect based on scheduled dates when they will be in a similar region. This may be especially useful for travelling workers, relocating workers, students attending a university in the future, or individuals who are travelling.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate to a system and method for providing a platform for matching users in the process of work relocation, general relocation, or travel, the system including at least one user computing device in operable connection with a user network. An application server is in operable communication with the user network to host an application system for providing a communication platform for work relocation, general relocation, or travel, the application system having a user interface module for providing access to the application system through the user computing device. A matching module in communication with the application program to match two or more users using a plurality of user-input parameters. A communication module permits the two or more matched users to communicate using the communication platform.

A method for matching users in the process of work relocation, general relocation, or travel, is provided. First the user module generates a user account associated with a first user. The user then inputs a plurality of user information which is stored in a user database. The plurality of user information associated with the user account to create a user card associated with each user. The user may also input at least one event. The matching module then filters one or more user cards and displays the filtered one or more user cards to at least a second user.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 shows a block diagram of a computing system, according to some embodiments;

FIG. 2 shows a block diagram of a computing system and an application program, according to some embodiments;

FIG. 3 illustrates a block diagram of the application program and databases, according to some embodiments;

FIG. 4 illustrates a screenshot of the user profile interface, according to some embodiments;

FIG. 5 illustrates a screenshot of the user card interface, according to some embodiments;

FIG. 6 illustrates a screenshot of the matching filter interface, according to some embodiments;

FIG. 7 illustrates a screenshot of the user connection interface, according to some embodiments;

FIG. 8 illustrates screenshots of the travel connection interface, according to some embodiments;

FIG. 9 illustrates screenshots of the personal connection interface, according to some embodiments;

FIG. 10 illustrates screenshots of the professional connection interface, according to some embodiments;

FIG. 11 illustrates screenshots of the discovery page and view experts interfaces, according to some embodiments;

FIG. 12 illustrates screenshots of the audio or video call with an expert interfaces, according to some embodiments;

FIG. 13 illustrates screenshots of the PDF and video booklet interfaces, according to some embodiments;

FIG. 14 illustrates screenshots of the booklet library and expert sessions interfaces, according to some embodiments;

FIG. 15 illustrates screenshots of the student and alumni profile interfaces, according to some embodiments;

FIG. 16 illustrates screenshots of the alumni and student search interfaces, according to some embodiments;

FIG. 17 illustrates screenshots of the business profile (from the owner and user views) interfaces, according to some embodiments;

FIG. 18 illustrates screenshots of the business insights and bios interfaces, according to some embodiments;

FIG. 19 illustrates screenshots of the group discovery and group profile interfaces, according to some embodiments; and

FIG. 20 illustrates screenshots of the group feed and group listing interfaces, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before various example embodiments are described in detail, it is noted that the embodiments reside primarily in combinations of components and procedures related to systems. Accordingly, system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be systems, methods, and/or computer program products at any possible technical detail level of integration. A computer program product can include, among other things, a computer-readable storage medium having computer-readable program instructions thereon for causing a processor to carry out aspects of the present disclosure.

In general, the embodiments provided herein relate to systems and methods for providing a platform for matching users in the process of work relocation, general relocation, or travel. In such, the system and method allow for users to connect with one another prior to moving to a new location for work, travel, or personal reasons. The advantage of this system and method is to allow a user to connect with another user and message them directly in a new city that both of the users will be relocating to months ahead of time. The new matching and filtering system (location and dates, day/month/year) will display users to other users who will be in the same city for the same time period. Current apps that allow people to connect in this format require the user to have already moved or be in the new city to then begin matching with others in the area.

The system uses the algorithms of matching users to connect with one another with the inputted dates (day/month/year) from the user and the location (city) that the user selected. Unlike current applications that are built for people to connect with one another in the present within the same city (via phone GPS location), this software focuses on connecting people together who will either be traveling or relocating for work purposes months in advance. In such, when the user has relocated to the new city, they will have effectively connected with people prior to moving. Additional filtering options based on the company the user will work for, the interests that the user selected, gender, age, and mile range within city will all contribute to the user experience of being able to connect with others.

This application covers multiple use cases for individuals who are relocating to a new city for an internship, full-time job, a university, or traveling nurse. This app also allows users to connect with others who will be traveling to the same location for the same dates, months in advance.

In one example, a user may utilize the system ahead of an internship. Once an individual signs an internship (let's say in February of 2023) they can install the application and make an event card on their profile about their internship information. Including where they will be interning, which city they will be interning in, the start and end date (day/month/year) of the internship, and a personal message for the event. Then, the user can head to the feed page where the application algorithm (by default) will display event cards of other users who will also be in the same city and have either the same or overlapping dates (let's say for May 2023-August 2023) to be shown. From here the user can connect with other users before moving.

In one example, a user may utilize the system ahead of a full-time work opportunity. This example is relatively the same as an internship, but the event card will not have an explicit end date. Instead, a selected month automatic period will be applied to the event. Then, the event will be “expired”, and the user will not be displayed in the feed deck to other users after the selected month period. Or, until the user deletes the event.

In one example, a user may utilize the system ahead of university attendance. The user will input into their event card which University they plan to attend and which Semester (Spring, Summer, Fall) they will be attending. The application algorithm will have a specific day/month/year tied to each of these options and will filter events cards in the deck based on this criteria. The expiration of the University event will have the same procedure as the Full-time option.

In one example, a user may utilize the system ahead of a traveling nurse employment opportunity. The user may input into their event card the city that they will be relocating to with the date of the move (day/month/year). The expiration of the event card will follow the same procedure as for Full-time and University.

In one example, a user may utilize the system ahead of travelling. The user will input into their event card the city they will be traveling to and the day/month/year that they will be arriving and leaving their trip. To connect with other users, the same procedure as described in the “Internship” section will be utilized.

For user safety, the exact day/month/year will not be shown to other users. The event card will not display this information for it is only used behind the scenes within the algorithm to display the event card. The user's location will also not explicitly be shown on the event card.

Additional methods of this invention would include further filter options. Such as, but not limited to, filtering event cards based on the company of the user, the gender of the user, the age of the user, the type of event (internship/full-time/travel/university/traveling nurse) of the user and the distance within the city (up to 100 miles) of the user. Current applications in the arts use the GPS coordinates of the user's phone to display potential matches between users. As well as adding additional filters such as the user's age, gender, and distance (up to 100 miles).

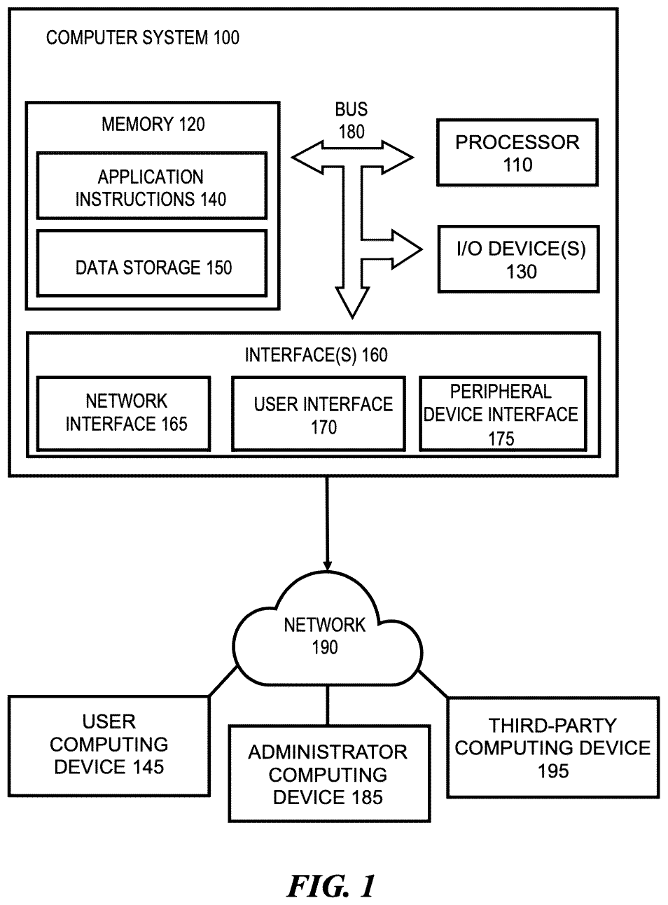

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar IO devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, 1?read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

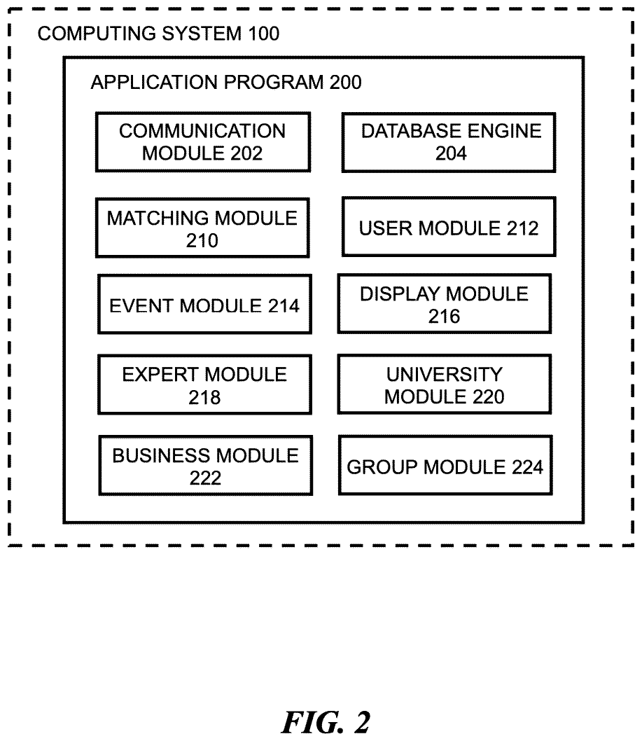

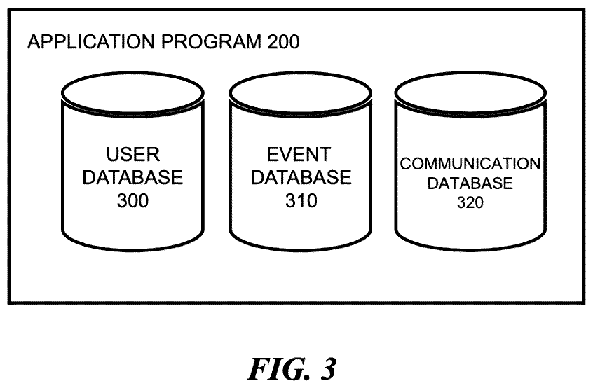

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a matching module 210, a user module 212, an event module 214, a display module 216, an expert module 218, a university module 220, business module 222, and a group module 224.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 210 allows two or more matched users to communicate with one another once they have been successfully matched.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the matching module 210 is in operable communication with the computing device to match two or more users using a plurality of user input parameters. The user input parameters may include any of the following: a date, location, start date, end date, user interests, gender, age, and a radius associated with the location.

In some embodiments, the user module 212 facilitates the creation of a user account for the application system. The user module 212 may allow the user to create a user profile which includes user information, a user card, interests, age, gender, etc.

In some embodiments, the event module 214 is in operable communication with the computing device to permit the user to create an event such as an employment opportunity, work relocation event, travelling event, internship event, university attendance and the like. The event is then displayed on the user card.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the display module 216 may allow the user card to be displayed during the user matching process. The display module 216 may display any user input parameters or information such that users may determine appropriate matches while viewing personal information associated with other users.

In some embodiments, the expert module 218 is in communication with the application program to allow a user to register (following a verification process) as an “Expert”. The Expert may upload video and PDF documents displaying information pertaining to the interests (e.g., working at a specific company, specific restaurants, town safety, local groups) and the location (city/state) of the Expert to another user (the “Learner”). The Expert may also host audio and video calls with the “Learner” to share information regarding to the “Expert's” and “Learner's” shared interests and location. The expert module 218 is designed to help users traveling and/or relocating to learn more about a city of interest directly from another user who currently resides in that city.

In some embodiments, the university module 220 is in communication with the application program to provide a segment for students and alumni from a university to create an account and connect with other members (students and alumni) from the same university. Searchable results are based on user's name (first/last), graduation month/year, degree field (e.g., Electrical Engineering), type of degree (e.g., B.S.), professional societies/organizations (e.g., IEEE: Institute of Electrical and Electronics Engineers), fraternity or sorority, and school clubs/activities. Students and Alumni will also be able to search for Alumni (from the same university) based on location (city/state). The university module 220 provides an outlet for relocating student/alumni to network with other alumni currently in their city of relocation for information sharing purposes (regarding moving, the city, etc.).

In some embodiments, the business module 222, is in communication with the application program to allow individuals to create a Business Profile to load in the search results on the discovery page for other users to view. The Business Profile encompasses uploaded image(s) of the organization, the name of the organization, information (address, website, phone, email), public reviews (submitted by app users), a bio about the organization, and information about the owner(s) and/or representatives (as an optional feature for the business owner). The business module 222 allows users to message the owner(s) directly through the application through secure messaging to address specific questions about the business.

In some embodiments, the group module 224 is in communication with the application program to permit users to search for groups to follow based on the users' interests and location. Group profiles would display the name of the group, photo(s) of the group, follower count, button to follow/unfollow, bio about the group, the group administrator(s) and owner(s), as well as the announcements made by the group owner(s)/administrator(s).

FIG. 3 illustrates a block diagram of the application program 200 and databases including a user database 300, an event database 310 and a communication database 320. The user database 300 stores user information, user input parameters, and the user card associated with the user. The event database 310 stores event information which has been created by the user. The communication database 320 stores communications between each user.

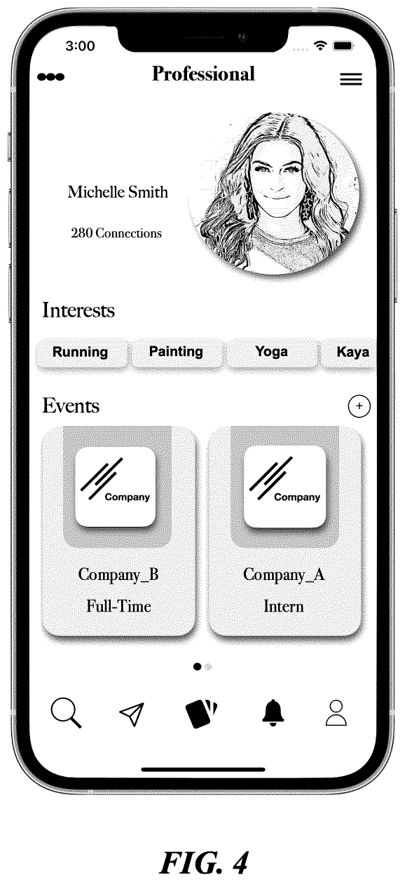

FIG. 4 illustrates a screenshot of the user profile interface 400. The user profile interface includes a plurality of user input information and user input parameters to create a user card 410. This includes a user's name, user image, interests, events, and other user associated information. The user card 410 is displayed to other users during the matching process and/or to other matched users.

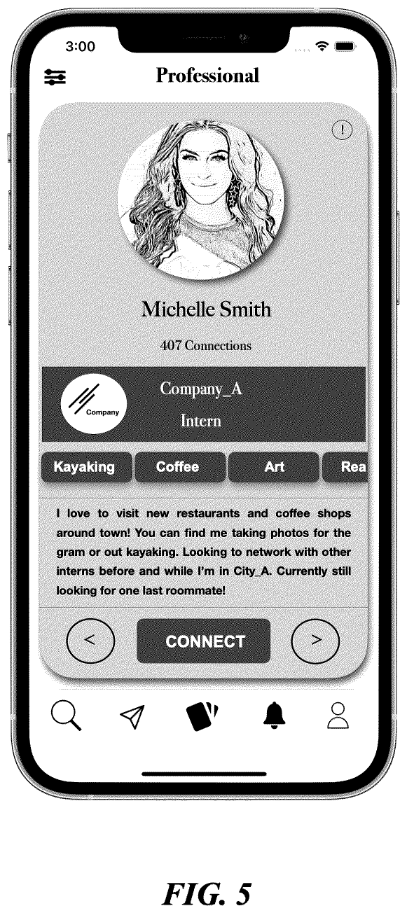

FIG. 5 illustrates a screenshot of the user card interface 500 which includes at least a portion of the user card 410. The user card interface 500 allows the user to connect with the user displayed on the user card 410. The user card interface 500 is displayed once the system has determined that the users are appropriate to connect based on the various user input parameters.

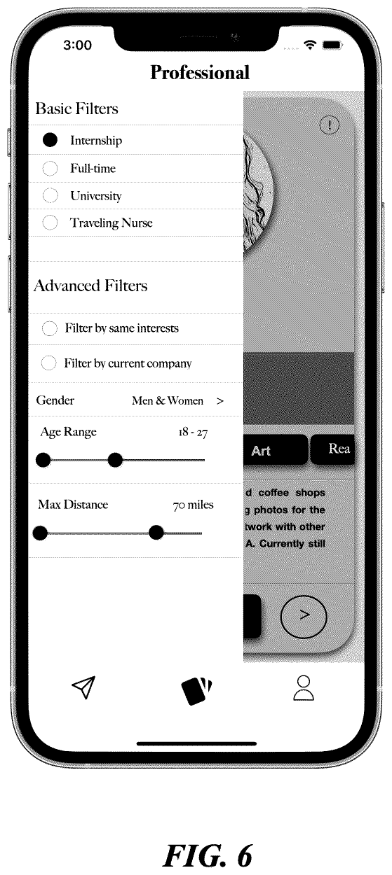

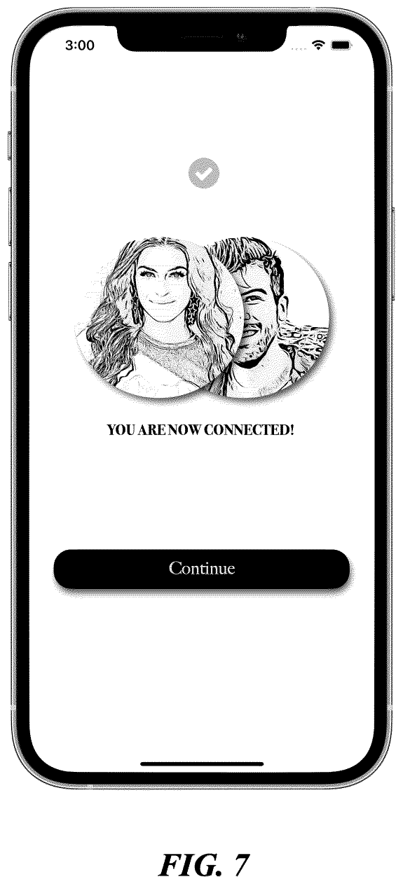

FIG. 6 illustrates a screenshot of the matching filter interface 600 wherein users may select from one or more filters to display users they are interested in matching with. For example, filters may include event types, ages, distance and location, interests, etc. FIG. 7 illustrates a screenshot of the user connection interface 700 which displays a successful connection between the users.

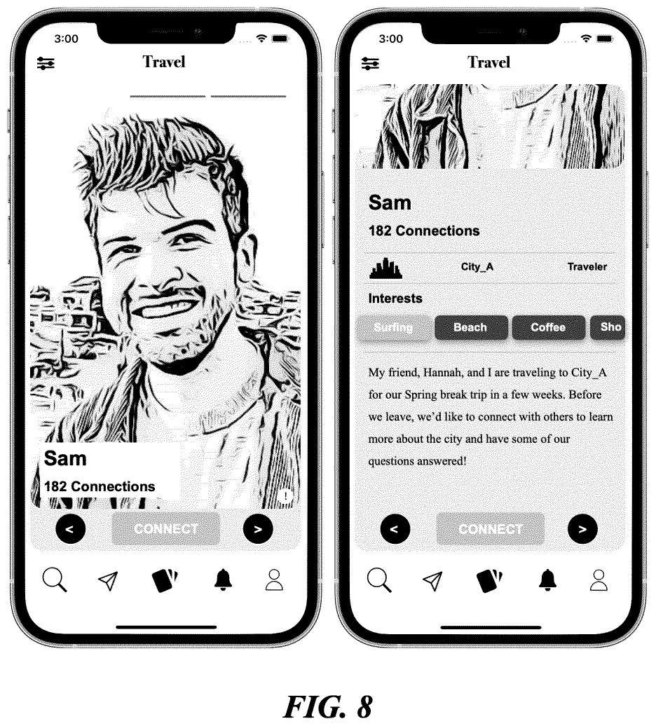

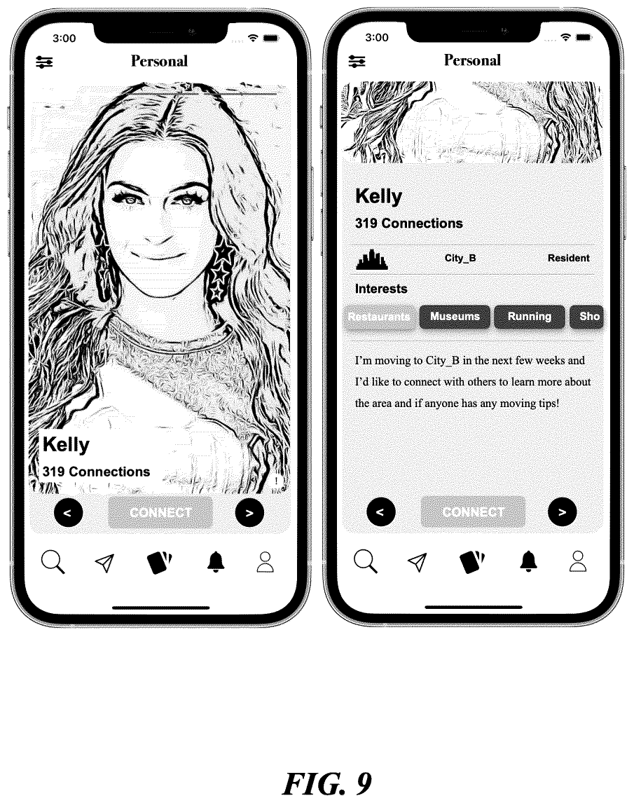

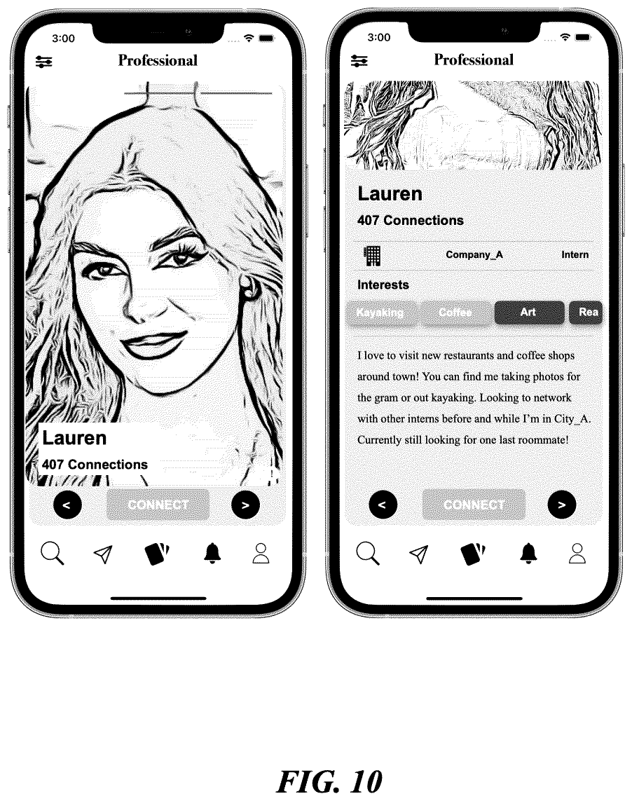

FIGS. 8-10 illustrate screenshots associated with the matching module 210. The screenshots include the travel connection interface (see FIG. 8), the personal connection interface (see FIG. 9) and the professional connection interface (see FIG. 10). The matching module 210 displays each interface once a match is made between each user to allow the matched users to connect with one another.

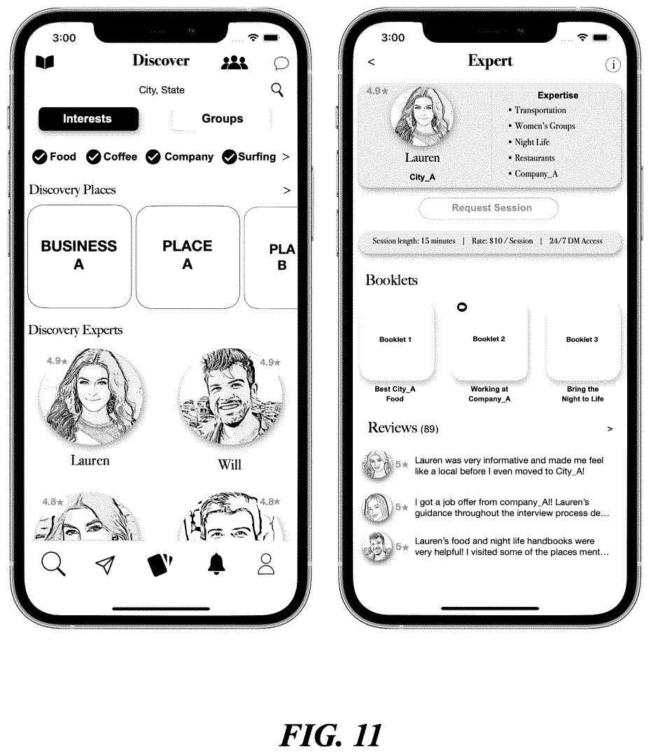

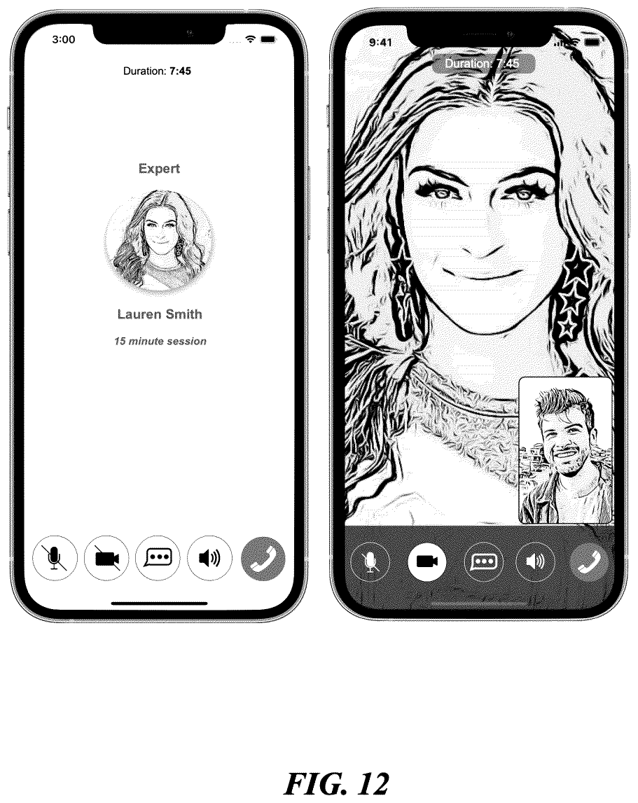

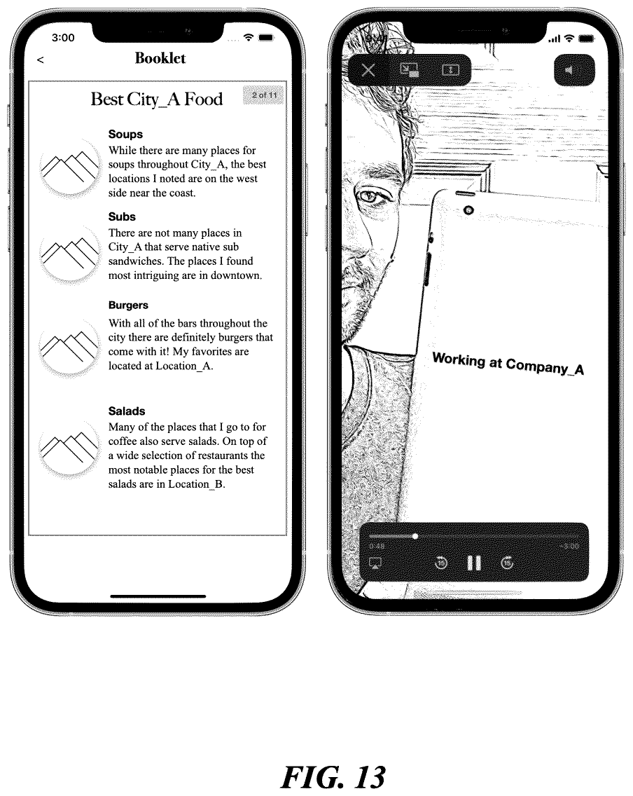

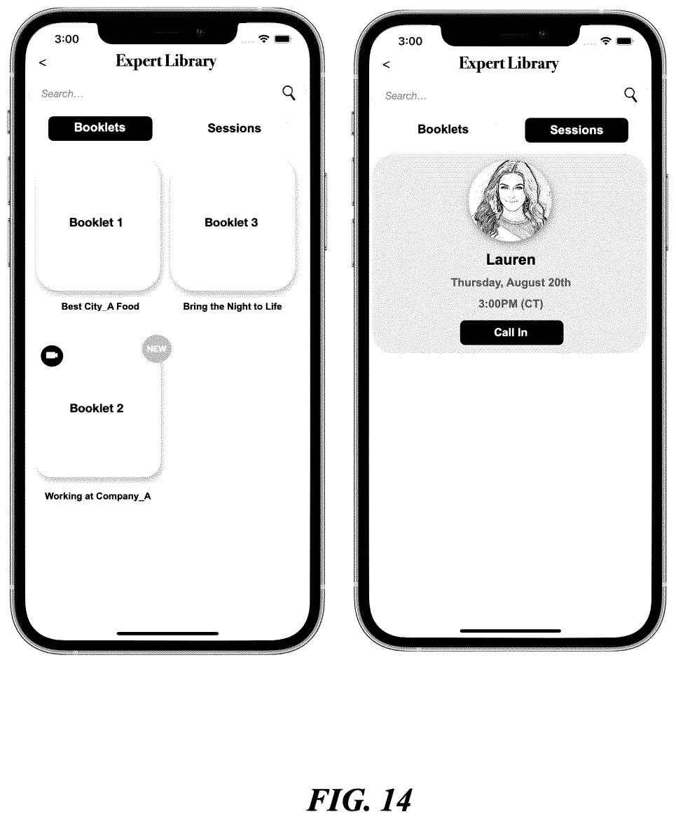

FIGS. 11-14 illustrate screenshots associated with the experts module 218. FIG. 11 illustrates the expert discovery and profile interfaces wherein users may search for experts and view expert profiles, while allowing users to connect and communicate with experts. Users may initiate an audio and/or video call with experts (see FIG. 12) to communicate with the expert, ask questions, and gain knowledge associated with the area of expertise the expert has. Users may also interact with expert content including booklets, videos, and other media (see FIGS. 13-14).

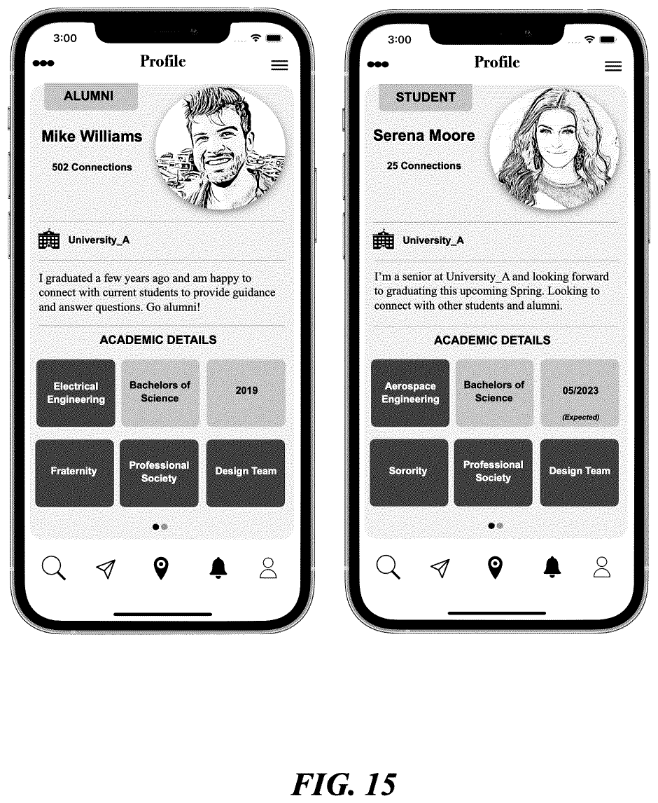

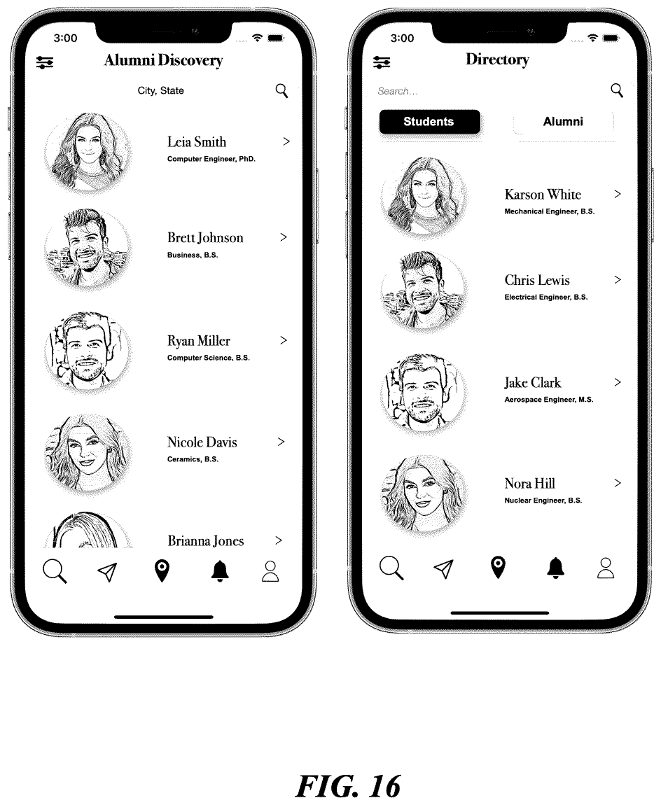

FIGS. 15-16 illustrate screenshots associated with the university module 220. FIG. 15 provides alumni and student profiles which can be viewed by other users while FIG. 16 provides an interface wherein users may search for alumni or students.

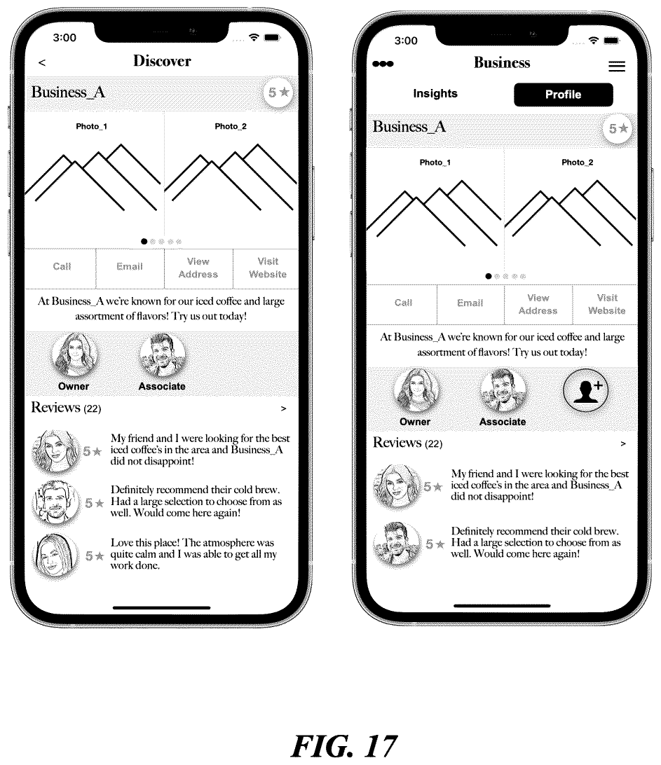

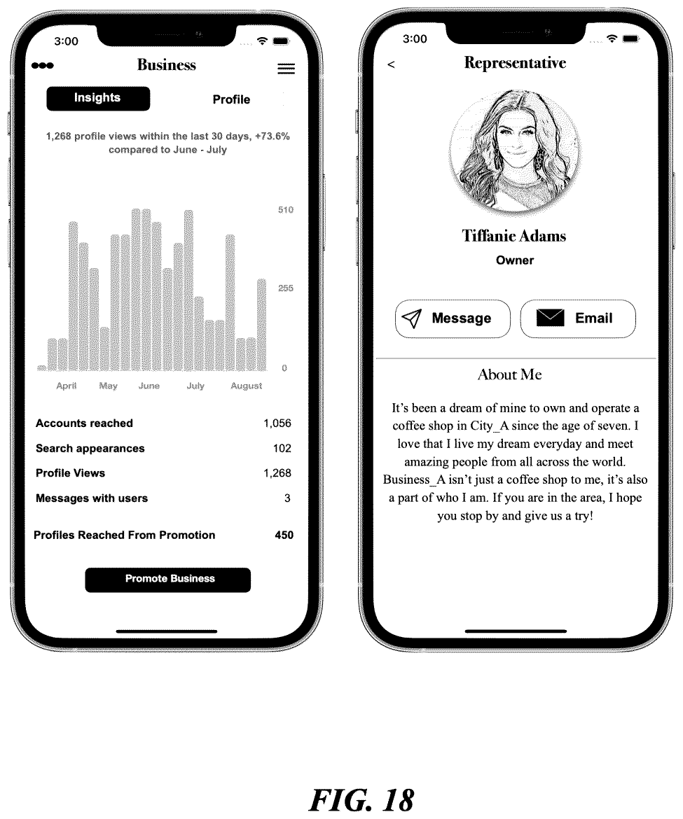

FIGS. 17-18 illustrate screenshots associated with the business module 222 including the business profile interface from both the user and owner perspectives. This allows users to view business information, including services provided, business insights, and business owner information.

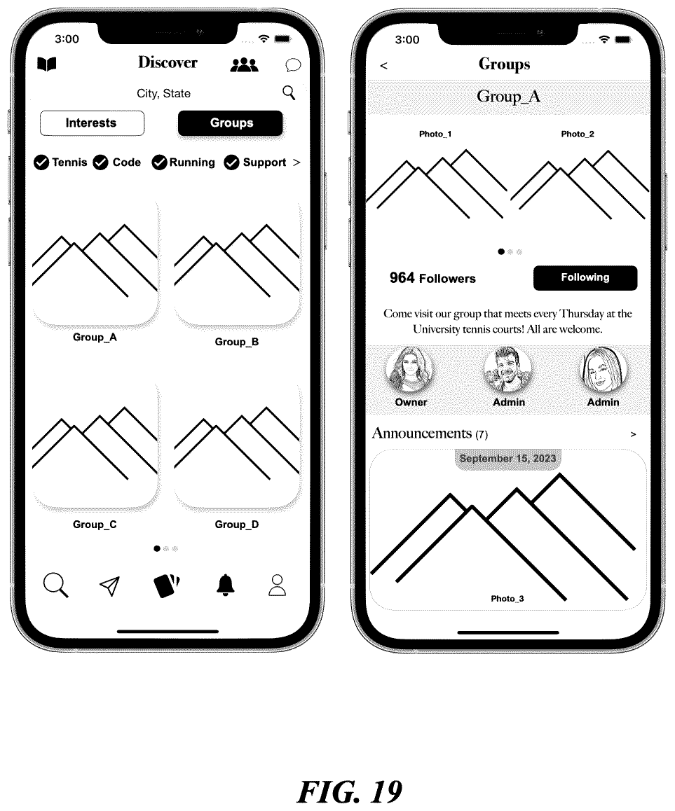

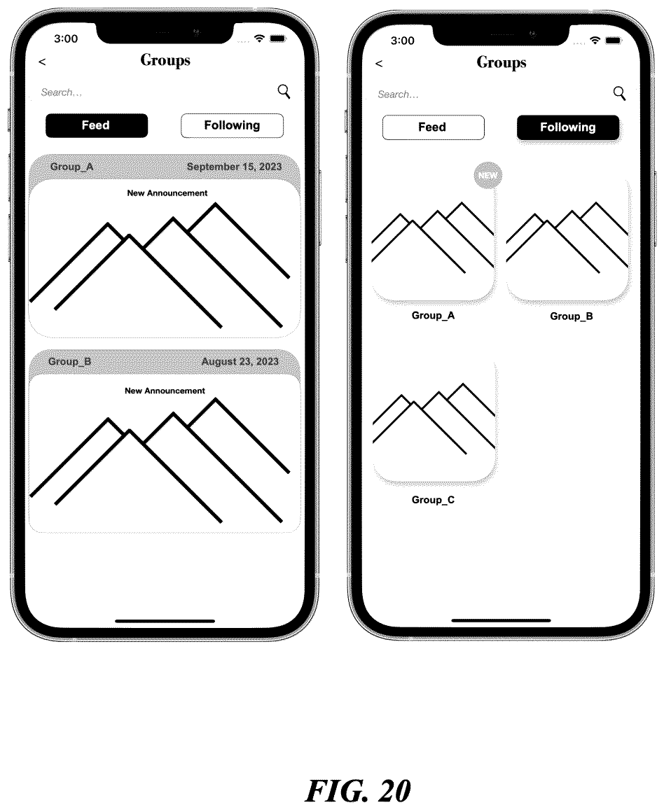

FIGS. 19-20 illustrate screenshots associated with the group module 224 including the group discover and profile interfaces which allow users to view group information and search groups which match their interests. Users may follow one or more groups to provide them with a feed associated with the groups they follow, interact with the groups they follow, and otherwise interface with the groups they are interested in.

A method for matching users in the process of work relocation, general relocation, and travel, is provided. First the user module generates a user account associated with a first user. The user then inputs a plurality of user information which is stored in a user database. The plurality of user information associated with the user account to create a user card associated with each user. The user may also input at least one event. The matching module then filters one or more user cards and displays the filtered one or more user cards to at least a second user.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A platform for matching users in the process of work relocation, general relocation, or travel, the system comprising:
at least one user computing device in operable connection with a user network;
an application server in operable communication with the user network, the application server configured to host an application system for providing a communication platform for work relocation, general relocation, or travel, the application system having a user interface module for providing access to the application system through the user computing device;
a matching module in communication with the application program, the matching module to match two or more users using a plurality of user-input parameters; and
a communication module to permit the two or more matched users to communicate using the communication platform.

2. The system of claim 1, wherein the plurality of user-input parameters comprises a date and a location.

3. The system of claim 2, wherein the plurality of user-input parameters further comprises a company, one or more user interests, a gender, an age, and a radius associated with the location.

4. The system of claim 2, wherein the date is defined as the users start date and end date of employment, travel length, or personal move date.

5. The system of claim 4, wherein the communication module is in communication with a messaging interface to the two or more matched permit users to securely transmit messages to one another prior to each user's start date, between user's start and end date, and after user's end date.

6. The system of claim 5, further comprising a user module to permit the creation, via the user, of a user account.

7. The system of claim 6, wherein the user account is associated with a user card.

8. The system of claim 7, wherein the user card is comprised of a plurality of personal information and the plurality of user-input information.

9. The system of claim 8, wherein the matching module selects user cards to match the two or more users.

10. The system of claim 9, wherein the display module displays the user card associated with a first user to a second user.

11. A platform for matching users in the process of work relocation, general relocation, or travel, the system comprising:
at least one user computing device in operable connection with a user network;
an application server in operable communication with the user network, the application server configured to host an application system for providing a communication platform for work relocation, general relocation, or travel, the application system having a user interface module for providing access to the application system through the user computing device;
a matching module in communication with the application program, the matching module to match two or more users using a plurality of user-input parameters provided on a user card associated with each of the two or more users, the user card generated via a card module configured to receive the plurality of user-input parameters;
a communication module to permit the two or more matched users to communicate using the communication platform;
an event module to display on or more user-input events on the user card;
an expert module in operable communication with the application program to permit an expert to upload media content to be provided to the user, the expert module in operable communication with the communication module to permit the user and the expert to exchange information;
a business module in operable communication with the application program to permit a business to upload content to be provided to the user, the business module in operable communication with the communication module to permit the user and the business to exchange information; and
a database engine to allow a user to search a listing of one or more of the experts and one or more of the businesses.

12. The system of claim 11, wherein the plurality of user-input parameters comprises a date and a location.

13. The system of claim 12, wherein the plurality of user-input parameters further comprises a company, one or more user interests, a gender, an age, and a radius associated with the location.

14. The system of claim 13, wherein the date is defined as the users start date and end date of employment, travel length, or personal move date.

15. The system of claim 14, wherein the communication module is in communication with a messaging interface to the two or more matched permit users to securely transmit messages to one another prior to each user's start date, between user's start and end date, and after user's end date.

16. The system of claim 15, further comprising a user module to permit the creation, via the user, of a user account.

17. The system of claim 16, wherein the user card is comprised of a plurality of personal information and the plurality of user-input information.

18. The system of claim 17, wherein the user card is further comprised of at least one user image.

19. The system of claim 18, wherein the application program is in communication a user database to store a plurality of user account information.

20. A method for matching users in the process of work relocation, general relocation, or travel, the system comprising:
generating, via a user module, a user account associated with a first user;
inputting, via each user, a plurality of user information, the user information stored in a user database, the plurality of user information associated with the user account to create a user card associated with each user;
inputting, via each user, at least one event;
filtering, via a matching module, one or more user cards; and
displaying the filtered one or more user cards to at least a second user.
